(19) United States
(12) Patent Application Publication
(10) Pub. No.: US 2026/0340756 A1
(43) Pub. Date: Oct. 29, 2026

(54) VIDEO WATERMARK GENERATION METHOD AND APPARATUS, MEDIUM, ELECTRONIC DEVICE AND PROGRAM PRODUCT

(71) Applicant: Bytedance Technology Ltd., Grand Cayman (KY)

(72) Inventor: Fan ZHONG, Beijing (CN)

(21) Appl. No.: 19/663,033

(22) Filed: Apr. 29, 2026

(30) Foreign Application Priority Data
Apr. 29, 2025 (CN) 202510565365.7

(51) Int. Cl. G06T 1/00

(52) U.S. Cl. CPC G06T 1/0035; G06T 2201/0202

(57) ABSTRACT

A video watermark generation method and apparatus, a medium, an electronic device, and a program product. The method includes: determining benchmark values of watermark parameters of a video according to a first size of at least one video frame to which a watermark is to be added in the video; determining, for each video frame, a first scaling ratio according to the first size of the video frame and a second size of a watermark canvas, and scaling the benchmark values according to the first scaling ratio; and generating a watermark for the video frame based on the scaled benchmark values.

### CROSS-REFERENCE TO RELATED APPLICATION(S)

This application claims priority to Chinese Application No. 202510565365.7 filed April 29, 2025, the disclosure of which is incorporated herein by reference in its entirety.

### TECHNICAL FIELD

The present disclosure relates to the technical field of video processing, and specifically, to a video watermark generation method and apparatus, a medium, an electronic device and a program product.

### BACKGROUND

In a video social application, when a video is edited, as shown in FIG. 1, the video may be saved locally with a watermark. When the video is posted, as shown in FIG. 2, a copy of the video with the watermark may also be selected to be saved locally while the video is posted. The watermark in the video is generated in advance, and the size and the position of the watermark are fixed, and thus may not match the size of a video frame. For example, an excessively large watermark may cause visual interference, and an excessively small watermark may reduce the identification effect of the watermark, thereby affecting the video quality.

### SUMMARY

The Summary section is provided in order to introduce concepts in a brief form, and these concepts will be described in detail in the following Detailed Description section. The Summary section is not intended to identify key features or essential features of the claimed technical solutions, nor is it intended to limit the scope of the claimed technical solutions.

In a first aspect, the present disclosure provides a video watermark generation method, including:
determining benchmark values of watermark parameters of a video according to a first size of at least one video frame in the video, wherein the watermark parameters include a second size of a watermark canvas, a third size of a watermark, and a position offset of the watermark in the watermark canvas;
for each of the at least one video frame, determining a first scaling ratio according to the first size of the video frame and the second size;
scaling the benchmark values of the watermark parameters according to the first scaling ratio; and
generating a watermark for the video frame based on the scaled benchmark values.

In a second aspect, the present disclosure provides a video watermark generation apparatus, including:
a benchmark value determination module, configured to determine benchmark values of watermark parameters of a video according to a first size of at least one video frame in the video, wherein the watermark parameters include a second size of a watermark canvas, a third size of a watermark, and a position offset of the watermark in the watermark canvas;
a scaling ratio determination module, configured to: for each of the at least one video frame, determine a first scaling ratio according to the first size of the video frame and the second size;
a parameter scaling module, configured to scale the benchmark values of the watermark parameters according to the first scaling ratio; and
a watermark generation module, configured to generate a watermark for the video frame based on the scaled benchmark values.

In a third aspect, the present disclosure provides a computer-readable medium having a computer program stored thereon, wherein the computer program, when executed by a processing means, implements the steps of the video watermark generation method provided in the first aspect of the present disclosure .

In a fourth aspect, the present disclosure provides an electronic device, including:
a storage means having a computer program stored thereon; and
a processing means, configured to execute the computer program in the storage means to implement the steps of the video watermark generation method provided in the first aspect of the present disclosure.

In a fifth aspect, the present disclosure provides a computer program product including a computer program, wherein the computer program, when executed by a processor, implements the steps of the video watermark generation method provided in the first aspect of the present disclosure.

The other features and advantages of the present disclosure will be described in detail in the following Detailed Description section.

### BRIEF DESCRIPTION OF THE DRAWINGS

The above and other features, advantages and aspects of various embodiments of the present disclosure will become more apparent when taken in conjunction with the drawings and with reference to the following Detailed Description. Throughout the drawings, the same or similar reference numbers refer to the same or similar elements. It should be understood that the drawings are schematic and that the components and elements are not necessarily drawn to scale. In the drawings:

FIG. 1 is a schematic diagram of saving a video with a watermark when a video is edited according to an exemplary embodiment;

FIG. 2 is a schematic diagram of saving a video with a watermark while a video is posted according to an exemplary embodiment;

FIGS. 3A-3D are schematic diagrams of a video watermark in the related art;

FIG. 4 is a flowchart of a video watermark generation method according to an exemplary embodiment;

FIG. 5 is a schematic diagram of a position offset of a watermark according to an exemplary embodiment;

FIGS. 6A-6D are schematic diagrams of a video watermark according to an exemplary embodiment;

FIG. 7 is a block diagram of a video watermark generation apparatus according to an exemplary embodiment; and

FIG. 8 is a schematic structural diagram of an electronic device according to an exemplary embodiment.

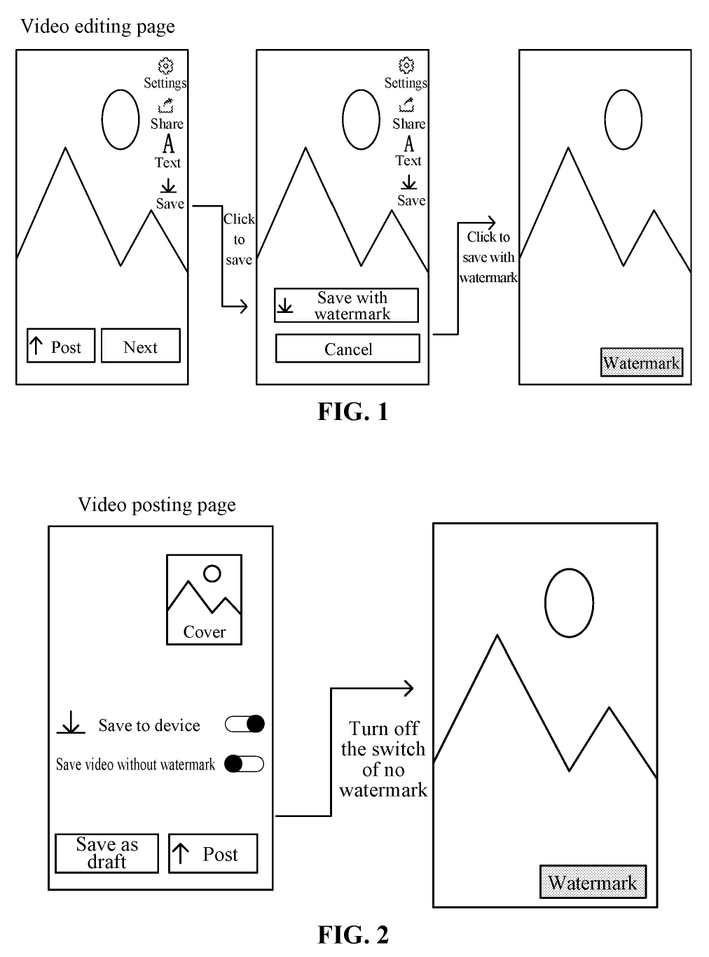

### DETAILED DESCRIPTION OF EMBODIMENTS

As discussed in the Background section, the watermark in the video is generated in advance, and the size and the position of the watermark are fixed, and thus may not match the size of a video frame. For example, an excessively large watermark may cause visual interference, and an excessively small watermark may reduce the identification effect of the watermark, thereby affecting the video quality.

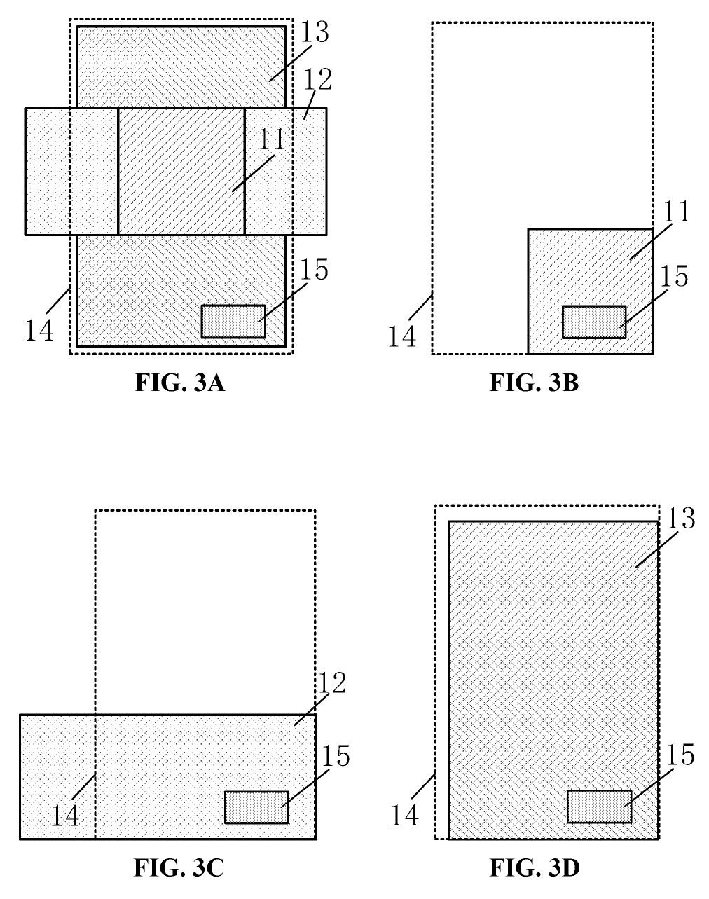

As shown in FIG. 3A, the video includes three video frames with different sizes, namely, a video frame 11, a video frame 12 and a video frame 13, wherein the video frame 11 is the smallest in size among the three video frames, the width of the video frame 12 is greater than the height thereof, and the width of the video frame 13 is smaller than the height thereof. A watermark 15 is a watermark generated in advance, wherein a watermark canvas 14 is a virtual canvas on which the watermark 15 is located.

As shown in FIG. 3B, the watermark 15 in the video frame 11 is relatively large, which may cause visual interference; as shown in FIG. 3C, the watermark 15 in the video frame 12 is relatively on the right; and as shown in FIG. 3D, the watermark 15 in the video frame 13 is relatively on the left.

In view of this, the present disclosure provides a video watermark generation method and apparatus, a medium, an electronic device and a program product.

Embodiments of the present disclosure will be described in more detail below with reference to the drawings. Although some embodiments of the present disclosure are shown in the drawings, it should be understood that the present disclosure may be implemented in various forms, and should not be construed as being limited to the embodiments set forth herein; on the contrary, these embodiments are provided for a more thorough and complete understanding of the present disclosure. It should be understood that the drawings and the embodiments of the present disclosure are only for illustrative purposes, and are not intended to limit the protection scope of the present disclosure.

It should be understood that various steps described in method implementations of the present disclosure may be performed in different orders, and/or performed in parallel. In addition, the method implementations may include additional steps and/or omit performing illustrated steps. The scope of the present disclosure is not limited in this regard.

The term "include/comprise" and the variations thereof used herein are open-ended inclusions, that is, "include/comprise but not limited to". The term "based on" is "at least partially based on". The term "an embodiment" means "at least one embodiment"; the term "another embodiment" means "at least one other embodiment"; the term "some embodiments" means "at least some embodiments". Related definitions of other terms will be given in the following description.

It should be noted that the concepts such as "first" and "second" mentioned in the present disclosure are only used to distinguish different means, modules or units, and are not used to limit the order or interdependence of the functions performed by these means, modules or units.

It should be noted that the modifications of "one" and "a plurality of" mentioned in the present disclosure are illustrative rather than restrictive, and those skilled in the art should understand that unless otherwise clearly indicated in the context, they should be understood as "one or more".

The names of messages or information exchanged between a plurality of means in the implementations of the present disclosure are only used for illustrative purposes, and are not used to limit the scope of these messages or information.

It may be understood that before the use of the technical solutions disclosed in various embodiments of the present disclosure, the user should be informed of the type, the range of use, the use scenarios, etc. of personal information involved in the present disclosure and the authorization of the user should be obtained in an appropriate manner in accordance with relevant laws and regulations.

For example, in response to reception of an active request from a user, prompt information is sent to the user to clearly prompt the user that the requested operation will need to access and use personal information of the user. In this way, the user may independently choose, based on the prompt information, whether to provide the personal information to software or hardware, such as an electronic device, an application, a server or a storage medium, that performs operations of the technical solutions of the present disclosure.

As an optional but non-limiting implementation, in response to the reception of the active request from the user, the prompt information may be sent to the user in the form of, for example, a pop-up window, and the prompt information may be presented in text in the pop-up window. In addition, the pop-up window may also include a selection control for the user to choose whether to "agree" or "disagree" to provide the personal information to the electronic device.

It may be understood that the above process of notifying and obtaining user authorization is only illustrative, and does not constitute a limitation on the implementations of the present disclosure. Other manners that satisfy relevant laws and regulations may also be applied to the implementations of the present disclosure.

Meanwhile, it may be understood that the data involved in the technical solution (including but not limited to the data itself, the acquisition or the use of the data) should comply with the requirements of corresponding laws, regulations and related provisions.

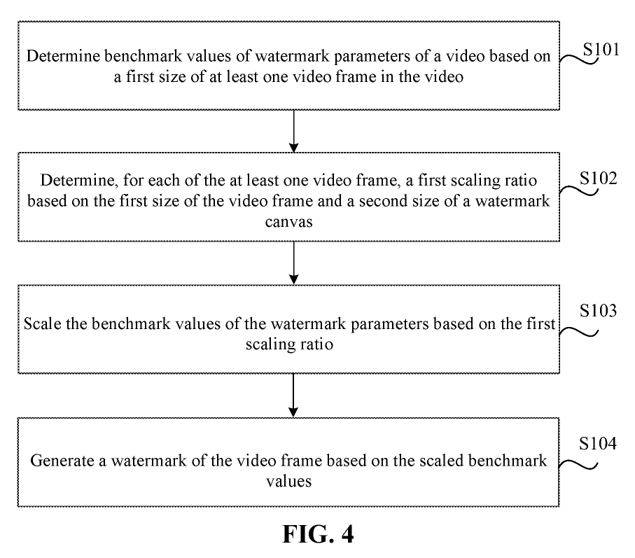

FIG. 4 is a flowchart of a video watermark generation method according to an exemplary embodiment. As shown in FIG. 4, the method may include the following S101-S104.

In S101, benchmark values of watermark parameters of a video are determined according to a first size of at least one video frame in the video.

In the present disclosure, the above method may be applied to a terminal, such as a smartphone or a tablet computer, and may also be applied to a server, which is not specifically limited in the present disclosure. In addition, the above video watermark generation method may be applied to a scenario where a video is saved locally with a watermark when the video is edited, may also be applied to a scenario where a copy of the video with the watermark is saved locally while the video is posted when the video is posted, and may also be applied to a scenario where the video with the watermark is posted.

In an implementation, the above video may be composed of a plurality of video clips, or may be composed of one video clip, wherein the video frames in one video clip have the same size.

In another implementation, the above video may be composed of a plurality of images, wherein the sizes of the plurality of images may be all the same, may be partially the same, or may be all different.

In addition, the at least one video frame in the video is a video frame to which a watermark is to be added in the video. All the video frames in the video may be taken as video frames to which watermarks are to be added, or part of the video frames in the video may be taken as video frames to which watermarks are to be added. For example, watermarks are added to frames with even-numbered serial numbers in the video. The number of the video frame to which the watermark is to be added may be one or more. When the number of the video frames to which the watermarks are to be added is multiple, the multiple video frames may include video frames of one size, that is, the multiple video frames have the same size, and may also include video frames of multiple sizes, which is not specifically limited in the present disclosure.

The first size may include a first width and a first height, that is, the first size of the video frame includes the first width of the video frame and the first height of the video frame. The watermark parameter may include a second size of a watermark canvas, a third size of a watermark, and a position offset of the watermark in the watermark canvas, wherein the second size may include a second width and a second height, the third size may include a third width and a third height, the watermark canvas may be a rectangular box, and the position offset of the watermark in the watermark canvas may include a horizontal offset and a vertical offset. The horizontal offset may be a horizontal distance of the watermark relative to a left border or a right border of the watermark canvas, and the vertical offset may be a vertical distance of the watermark relative to a lower border or an upper border of the watermark canvas.

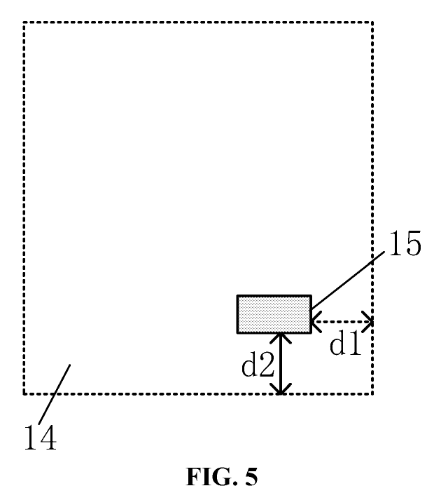

As shown in FIG. 5, the position offset of the watermark 15 in the watermark canvas 14 includes a horizontal distance d1 between the watermark 15 and the right border of the watermark canvas 14, and a vertical distance d2 between the watermark 15 and the lower border of the watermark canvas 14.

In S102, for each of the at least one video frame, a first scaling ratio is determined according to the first size of the video frame and the second size of the watermark canvas.

In S103, the benchmark values of the watermark parameters are scaled according to the first scaling ratio.

In the present disclosure, the benchmark values of the watermark parameters of the video are adjustment references for watermark parameters of subsequent video frames. For each of the at least one video frame, the first scaling ratio may be determined according to the first size of the video frame and the second size of the watermark canvas, and then the benchmark values of the watermark parameters are scaled according to the first scaling ratio, so that the watermark generated subsequently matches the size of the video frame. Scaling the benchmark values of the watermark parameters according to the first scaling ratio is equivalent to scaling, according to the first scaling ratio, the watermark and the watermark canvas corresponding to the benchmark values of the watermark parameters as a whole.

In S104, a watermark for the video frame is generated based on the scaled benchmark values.

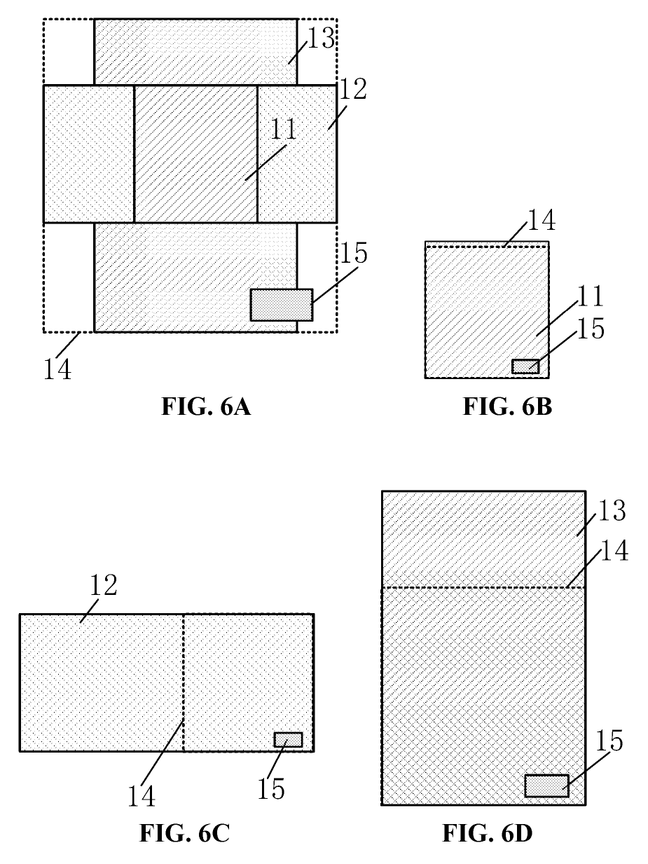

In the present disclosure, the watermark may be located at the lower right corner (as shown in FIG. 6A to FIG. 6D), the upper left corner, the upper right corner, the lower left corner, the center, etc. of the video frame, and the position of the watermark is not specifically limited in the present disclosure.

For each of at least one video frame, after the benchmark values of the watermark parameters are scaled according to the first size of the video frame, the watermark matching the size of the video frame may be generated based on the scaled benchmark values, and the watermark may be added to the video frame.

The scaling of the benchmark values of the watermark parameters according to the first scaling ratio specifically includes scaling the benchmark value of the second size of the watermark canvas, the benchmark value of the third size of the watermark, and the benchmark value of the position offset of the watermark in the watermark canvas according to the first scaling ratio, respectively. Then, the watermark for the video may be generated based on the scaled benchmark value of the second size, the scaled benchmark value of the third size, and the scaled benchmark value of the position offset.

In the above technical solutions, first, the benchmark values of the watermark parameters of the video are determined according to the first size of the at least one video frame in the video, wherein the watermark parameters include the second size of the watermark canvas, the third size of the watermark, and the position offset of the watermark in the watermark canvas; then, for each of the at least one video frame, the first scaling ratio is determined according to the first size of the video frame and the second size of the watermark canvas, and the benchmark values of the watermark parameters are scaled according to the first scaling ratio; and finally, the watermark for the video frame is generated based on the scaled benchmark values. The benchmark values of the watermark parameters only need to be calculated once based on the size of each video frame, and then the watermark parameters of each video frame may be scaled based on the benchmark values and according to the size of the video frame, so as to generate a watermark matching the size of the video frame. In this way, the memory occupancy and the computational complexity may be reduced, and the efficiency of generating the video watermark may be improved. In addition, the watermark in each video frame matches the size of the video frame, which may avoid visual interference caused by an excessively large watermark, and may also avoid a reduced identification effect caused by an excessively small watermark, so that the ownership or the source of the video may be clearly identified without interfering with the video content, thereby improving the video quality.

The specific implementation of determining the benchmark values of the watermark parameters of the video according to the first size of the at least one video frame in the video in the above S101 will be described in detail below. Specifically, it may be implemented through the following steps (a1) and (a2).

Step (a1): determining the benchmark value of the second size of the watermark canvas according to the first size of the at least one video frame.

Specifically, the maximum value of the first width of the at least one video frame may be determined as a benchmark value of a second width of the watermark canvas, and the maximum value of the first height of the at least one video frame may be determined as a benchmark value of a second height of the watermark canvas. In this way, each of the video frames to which the watermark is to be added may fall into the watermark canvas, which may ensure that the watermark of each video frame generated subsequently is not offset due to different video frame sizes, for example, the watermark is offset to the left, the watermark is offset to the right, the watermark is offset upward, and the watermark is offset downward.

As shown in FIG. 6A, the video includes three video frames with different sizes, namely, a video frame 11, a video frame 12 and a video frame 13, wherein the video frame 11 is the smallest in size among the three video frames, the width of the video frame 12 is greater than the height thereof, and the width of the video frame 13 is smaller than the height thereof. The first width of the video frame 12 is the maximum value of the first width of the three video frames, and the first height of the video frame 13 is the maximum value of the first height of the three video frames. Therefore, the second width of the watermark canvas 14 is equal to the first width of the video frame 12, and the second height of the watermark canvas 14 is equal to the first height of the video frame 13.

Step (a2): determining the benchmark value of the third size and the benchmark value of the position offset according to the benchmark value of the second size.

Specifically, the benchmark value of the third size and the benchmark value of the position offset may be determined according to the benchmark value of the second size through the following steps (a21) to (a23).

Step (a21): acquiring preset values of the watermark parameters.

In the present disclosure, values of the watermark parameters may be set in advance, and the values of the watermark parameters set in advance are the preset values of the watermark parameters.

Step (a22): determining a second scaling ratio according to the benchmark value of the second size and a preset value of the second size.

Step (a23): scaling a preset value of the third size with the second scaling ratio to obtain the benchmark value of the third size, and scaling a preset value of the position offset with the second scaling ratio to obtain the benchmark value of the position offset.

In the present disclosure, since the third size includes a third height and a third width, the preset value of the third size includes a preset value of the third height and a preset value of the third width, and the benchmark value of the third size includes a benchmark value of the third height and a benchmark value of the third width. Since the position offset includes the horizontal offset and the vertical offset, the preset value of the position offset includes a preset value of the horizontal offset and a preset value of the vertical offset, and the benchmark value of the position offset includes a benchmark value of the horizontal offset and a benchmark value of the vertical offset.

Specifically, a product of the second scaling ratio and the preset value of the third width may be determined as the benchmark value of the third width, and a product of the second scaling ratio and the preset value of the third height may be determined as the benchmark value of the third height. A product of the second scaling ratio and the preset value of the horizontal offset may be determined as the benchmark value of the horizontal offset, and a product of the second scaling ratio and the preset value of the vertical offset may be determined as the benchmark value of the vertical offset.

In the above implementation, the benchmark values of the watermark parameters may be obtained through simple numerical calculation based on the size of each video frame to which the watermark is to be added, which is convenient and fast, and thus the efficiency of generating the watermark may be improved.

The specific implementation of determining the second scaling ratio according to the benchmark value of the second size and the preset value of the second size in the above step (a22) will be described in detail below. Specifically, it may be implemented through the following steps (a221) to (a225).

Step (a221): calculating a first ratio of the benchmark value of the second width to the benchmark value of the second height, and a second ratio of the preset value of the second width to the preset value of the second height.

Step (a222): determining whether the first ratio is greater than the second ratio.

In the present disclosure, the first ratio is an aspect ratio of the watermark canvas (referred to as a watermark canvas SY1 for short) corresponding to the benchmark value of the second size, and the second ratio is an aspect ratio of the watermark canvas (referred to as a watermark canvas SY2 for short) corresponding to the preset value of the second size. If the first ratio is greater than the second ratio, it indicates that the watermark canvas SY1 is wider than the watermark canvas SY2. At this time, the watermark canvas SY2 may be scaled first so that the height of the scaled watermark canvas SY2 is the same as the height of the watermark canvas SY1, and then a ratio of the benchmark value of the second width to the width of the scaled watermark canvas SY2 is determined as the second scaling ratio. The process may be converted into the following mathematical calculation: calculating a third ratio of the benchmark value of the second width to the preset value of the second width, and a fourth ratio of the preset value of the second height to the benchmark value of the second height, that is, step (a223); and determining a product of the third ratio and the fourth ratio as the second scaling ratio, that is, step (a224). Therefore, if the first ratio is greater than the second ratio, the following steps (a223) and (a224) are executed.

If the first ratio is not greater than the second ratio, the following step (a225) is executed.

Step (a223): calculating the third ratio of the benchmark value of the second width to the preset value of the second width, and the fourth ratio of the preset value of the second height to the benchmark value of the second height.

Step (a224): determining the product of the third ratio and the fourth ratio as the second scaling ratio.

Step (a225): determining whether the first ratio is less than the second ratio.

If the first ratio is less than the second ratio, it indicates that the watermark canvas SY1 is higher than the watermark canvas SY2. At this time, the watermark canvas SY2 may be scaled first so that the width of the scaled watermark canvas SY2 is the same as the width of the watermark canvas SY1, and then a ratio of the benchmark value of the second height to the height of the scaled watermark canvas SY2 is determined as the second scaling ratio. The process may be converted into the following mathematical calculation: calculating a fifth ratio of the benchmark value of the second height to the preset value of the second height, and a sixth ratio of the preset value of the second width to the benchmark value of the second width, that is, step (a226); and determining a product of the fifth ratio and the sixth ratio as the second scaling ratio, that is, step (a227). Therefore, if the first ratio is less than the second ratio, the following steps (a226) and (a227) are executed.

If the first ratio is equal to the second ratio, it indicates that the watermark canvas SY1 and the watermark canvas SY2 are similar rectangles. At this time, the third ratio may be directly determined as the second scaling ratio, that is, the following step (a228) is executed.

Step (a226): calculating the fifth ratio of the benchmark value of the second height to the preset value of the second height, and the sixth ratio of the preset value of the second width to the benchmark value of the second width.

Step (a227): determining a product of the fifth ratio and the sixth ratio as the second scaling ratio.

Step (a228): determining the third ratio as the second scaling ratio.

In the above implementation, the scaling problem of the watermark canvas is converted into simple mathematical calculation, which is not only easy to implement, but also improves the efficiency of generating the watermark.

The specific implementation of determining the first scaling ratio according to the first size of the video frame and the second size of the watermark canvas in the above S102 will be described in detail below. Specifically, it may be implemented through the following steps (b1) and (b2).

Step (b1): calculating a seventh ratio of the first width of the video frame to the benchmark value of the second width, and an eighth ratio of the first height of the video frame to the benchmark value of the second height.

Step (b2): determining the minimum value of the seventh ratio and the eighth ratio as the first scaling ratio.

Specifically, the scaled benchmark value of the second width is equal to a product of the benchmark value of the second width and the first scaling ratio, and the scaled benchmark value of the second height is equal to a product of the benchmark value of the second height and the first scaling ratio. The scaled benchmark value of the third width is equal to a product of the benchmark value of the third width and the first scaling ratio, and the scaled benchmark value of the third height is equal to a product of the benchmark value of the third height and the first scaling ratio. The scaled benchmark value of the horizontal offset is equal to a product of the benchmark value of the horizontal offset and the first scaling ratio, and the scaled benchmark value of the vertical offset is equal to a product of the benchmark value of the vertical offset and the first scaling ratio.

In the above implementation, the seventh ratio is a ratio of the width of the video frame to the width of the watermark canvas SY1, and the eighth ratio is a ratio of the height of the video frame to the height of the watermark canvas SY1. Scaling the watermark canvas SY1 according to the minimum value of the seventh ratio and the eighth ratio may make the scaled watermark closer to the shape of the video frame, thereby improving the degree of matching between the watermark and the video frame.

Exemplarily, as shown in FIG. 6A, the ratio (that is, the seventh ratio) of the width of the video frame 11 to the width of the watermark canvas SY1 is smaller than the ratio (the eighth ratio) of the height of the video frame 11 to the height of the watermark canvas SY1. At this time, the seventh ratio may be determined as the first scaling ratio, and then the watermark 15 and the watermark canvas 14 in FIG. 6A may be scaled by the first scaling ratio as a whole, so as to obtain the watermark and the watermark canvas shown in FIG. 6B.

For another example, as shown in FIG. 6A, the ratio (that is, the seventh ratio) of the width of the video frame 12 to the width of the watermark canvas SY1 is greater than the ratio (the eighth ratio) of the height of the video frame 12 to the height of the watermark canvas SY1. At this time, the eighth ratio may be determined as the first scaling ratio, and then the watermark 15 and the watermark canvas 14 in FIG. 6A may be scaled by the first scaling ratio as a whole, so as to obtain the watermark and the watermark canvas shown in FIG. 6C.

For another example, as shown in FIG. 6A, the ratio (that is, the seventh ratio) of the width of the video frame 13 to the width of the watermark canvas SY1 is smaller than the ratio (the eighth ratio) of the height of the video frame 13 to the height of the watermark canvas SY1. At this time, the seventh ratio may be determined as the first scaling ratio, and then the watermark 15 and the watermark canvas 14 in FIG. 6A may be scaled by the first scaling ratio as a whole, so as to obtain the watermark and the watermark canvas shown in FIG. 6D.

In addition, if there are video frames with the same first size in the at least one video frame, the first scaling ratios corresponding to these video frames with the same first size are the same. Therefore, in order to simplify the calculation, it is only necessary to calculate the first scaling ratio corresponding to any one of these video frames with the same first size, and the first scaling ratio corresponding to this video frame may be directly reused when generating watermarks for other video frames with the same size.

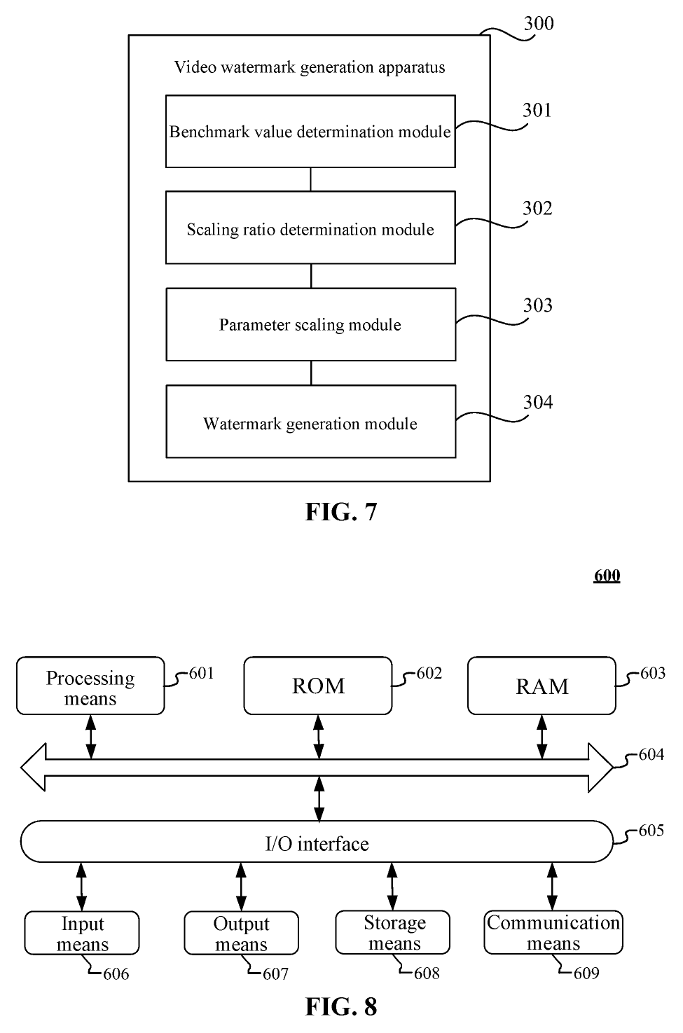

FIG. 7 is a block diagram of a video watermark generation apparatus according to an exemplary embodiment. As shown in FIG. 7, the video watermark generation apparatus 300 may include:

a benchmark value determination module 301, configured to determine benchmark values of watermark parameters of a video according to a first size of at least one video frame in the video, wherein the watermark parameters include a second size of a watermark canvas, a third size of a watermark, and a position offset of the watermark in the watermark canvas;

a scaling ratio determination module 302, configured to: for each of the at least one video frame, determine a first scaling ratio according to the first size of the video frame and the second size;

a parameter scaling module 303, configured to scale the benchmark values of the watermark parameters according to the first scaling ratio; and

a watermark generation module 304, configured to generate a watermark for the video frame based on the scaled benchmark values.

In the above technical solutions, first, the benchmark values of the watermark parameters of the video are determined according to the first size of the at least one video frame in the video, wherein the watermark parameters include the second size of the watermark canvas, the third size of the watermark, and the position offset of the watermark in the watermark canvas; then, for each of the at least one video frame, the first scaling ratio is determined according to the first size of the video frame and the second size of the watermark canvas, and the benchmark values of the watermark parameters are scaled according to the first scaling ratio; and finally, the watermark for the video frame is generated based on the scaled benchmark values. The benchmark values of the watermark parameters only need to be calculated once based on the size of each video frame, and then the watermark parameters of each video frame may be scaled based on the benchmark values and according to the size of the video frame, so as to generate a watermark matching the size of the video frame. In this way, the memory occupancy and the computational complexity may be reduced, and the efficiency of generating the video watermark may be improved. In addition, the watermark in each video frame matches the size of the video frame, which may avoid visual interference caused by an excessively large watermark, and may also avoid a reduced identification effect caused by an excessively small watermark, so that the ownership or the source of the video may be clearly identified without interfering with the video content, thereby improving the video quality.

Optionally, the benchmark value determination module 301 includes:
a first determination sub-module, configured to determine a benchmark value of the second size according to the first size of the at least one video frame; and
a second determination sub-module, configured to determine a benchmark value of the third size and a benchmark value of the position offset according to the benchmark value of the second size.

Optionally, the first size includes a first width and a first height, and the second size includes a second width and a second height; and

the first determination sub-module is configured to determine a maximum value of the first width of the at least one video frame as a benchmark value of the second width, and determine a maximum value of the first height of the at least one video frame as a benchmark value of the second height.

Optionally, the second determination sub-module includes:
an acquisition sub-module, configured to acquire preset values of the watermark parameters;
a third determination sub-module, configured to determine a second scaling ratio according to the benchmark value of the second size and a preset value of the second size; and
a scaling sub-module, configured to scale a preset value of the third size with the second scaling ratio to obtain the benchmark value of the third size, and scale a preset value of the position offset with the second scaling ratio to obtain the benchmark value of the position offset.

Optionally, the second size includes a second width and a second height; and the third determination sub-module includes:
a first calculation sub-module, configured to calculate a first ratio of the benchmark value of the second width to a benchmark value of the second height, and a second ratio of a preset value of the second width to a preset value of the second height;
a second calculation sub-module, configured to: if the first ratio is greater than the second ratio, calculate a third ratio of the benchmark value of the second width to the preset value of the second width, and a fourth ratio of the preset value of the second height to the benchmark value of the second height; and
a fourth determination sub-module, configured to determine a product of the third ratio and the fourth ratio as the second scaling ratio.

Optionally, the third determination sub-module further includes:
a third calculation sub-module, configured to: if the first ratio is less than the second ratio, calculate a fifth ratio of the benchmark value of the second height to the preset value of the second height, and a
sixth ratio of the preset value of the second width to the benchmark value of the second width; and
a fifth determination sub-module, configured to determine a product of the fifth ratio and the sixth ratio as the second scaling ratio.

Optionally, the third determination sub-module further includes:
a sixth determination sub-module, configured to: if the first ratio is equal to the second ratio, determine the third ratio as the second scaling ratio.

Optionally, the first size includes a first width and a first height, and the second size includes a second width and a second height; and
the scaling ratio determination module 302 includes: a fourth calculation sub-module, configured to calculate a seventh ratio of the first width of the video frame to the benchmark value of the second width, and
an eighth ratio of the first height of the video frame to the benchmark value of the second height; and
a seventh determination sub-module, configured to determine a minimum value of the seventh ratio and the eighth ratio as the first scaling ratio.

The present disclosure further provides a computer-readable medium having a computer program stored thereon, wherein the computer program, when executed by a processing means, implements the steps of the video watermark generation method provided by the present disclosure.

The present disclosure further provides an electronic device, including: a storage means having a computer program stored thereon; and a processing means, configured to execute the computer program in the storage means to implement the steps of the video watermark generation method provided by the present disclosure.

The present disclosure further provides a computer program product including a computer program, wherein the computer program, when executed by a processor, implements the steps of the video watermark generation method provided by the present disclosure.

Reference is made to FIG. 8 below, which illustrates a schematic diagram of a structure of an electronic device (a terminal device or a server) 600 suitable for implementing the embodiments of the present disclosure. The terminal device in the embodiments of the present disclosure may include, but is not limited to, mobile terminals such as a mobile phone, a notebook computer, a digital broadcasting receiver, a personal digital assistant (PDA), a tablet computer (PAD), a portable multimedia player (PMP), and an in-vehicle terminal (for example, an in-vehicle navigation terminal), and fixed terminals such as a digital TV and a desktop computer. The electronic device shown in FIG. 8 is merely an example, and should not impose any limitation on the functions and the range of use of the embodiments of the present disclosure.

As shown in FIG. 8, the electronic device 600 may include a processing means (e.g., a central processing unit, a graphics processing unit, etc.) 601 that may perform various appropriate actions and processing according to a program stored in a read-only memory (ROM) 602 or a program loaded from a storage means 608 into a random access memory (RAM) 603. The RAM 603 further stores various programs and data required for operations of the electronic device 600. The processing means 601, the ROM 602, and the RAM 603 are interconnected by means of a bus 604. An input/output (I/O) interface 605 is also connected to the bus 604.

Usually, the following means may be connected to the I/O interface 605: an input means 606 including, for example, a touch screen, a touchpad, a keyboard, a mouse, a camera, a microphone, an accelerometer, and a gyroscope; an output means 607 including, for example, a liquid crystal display (LCD), a speaker, and a vibrator; the storage means 608 including, for example, a magnetic tape and a hard disk; and a communication means 609. The communication means 609 may allow the electronic device 600 to communicate wirelessly or wiredly with other devices to exchange data. Although FIG. 8 shows the electronic device 600 having various means, it should be understood that not all the means shown herein need to be implemented or provided. More or fewer means may be implemented or provided alternatively.

In particular, according to the embodiments of the present disclosure, the process described above with reference to the flowchart may be implemented as a computer software program. For example, the embodiments of the present disclosure include a computer program product including a computer program carried on a non-transitory computer-readable medium, wherein the computer program contains program code for performing the method shown in the flowchart. In such an embodiment, the computer program may be downloaded and installed from a network via the communication means 609, or installed from the storage means 608, or installed from the ROM 602. When the computer program is executed by the processing means 601, the above functions defined in the method of the embodiments of the present disclosure are executed.

It should be noted that the above computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated on a baseband or as a part of a carrier, and computer-readable program code is carried in the data signal. The data signal propagated in this manner may be in multiple forms, and includes, but is not limited to, an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus or device. The program code contained on the computer-readable medium may be transmitted in any suitable medium, including but not limited to: a wire, an optical cable, a radio frequency (RF), etc., or any suitable combination of the above.

In some implementations, a client and a server may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The above computer-readable medium may be contained in the above electronic device, or may exist alone without being assembled into the electronic device.

The above computer-readable medium carries one or more programs that, when executed by the electronic device, cause the electronic device to perform the following operations: determining benchmark values of watermark parameters of a video according to a first size of at least one video frame in the video, wherein the watermark parameters include a second size of a watermark canvas, a third size of a watermark, and a position offset of the watermark in the watermark canvas; for each of the at least one video frame, determining a first scaling ratio according to the first size of the video frame and the second size; scaling the benchmark values of the watermark parameters according to the first scaling ratio; and generating a watermark for the video frame based on the scaled benchmark values.

The computer program code for performing the operations of the present disclosure may be written in one or more programming languages or a combination thereof, wherein the programming languages include, but are not limited to, an object-oriented programming language, such as Java, Smalltalk, and C++, and further include conventional procedural programming languages, such as "C" language or similar programming languages. The program code may be executed entirely on a computer of a user, partly executed on a computer of a user, executed as an independent software package, partly executed on a computer of a user and partly executed on a remote computer, or entirely executed on a remote computer or a server. In the case of involving the remote computer, the remote computer may be connected to the computer of the user through any kind of network, including a local area network (LAN) or a wide area network (WAN), or may be connected to an external computer (for example, connected via the Internet with the aid of an Internet service provider).

The flowcharts and block diagrams in the drawings illustrate the possibly implemented architectures, functions, and operations of the system, the method and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules involved in the embodiments of the present disclosure may be implemented by software or hardware. The name of a module does not constitute a limitation on the module itself under certain circumstances. For example, the watermark generation module may also be described as "a module that generates a watermark for a video frame based on a scaled benchmark value".

The functions described herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electrical, magnetic, optical, electromagnetic, infrared, or semiconductor system, apparatus, or device, or any suitable combination thereof. More specific examples of the machine-readable storage medium may include an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, Example 1 provides a video watermark generation method, including:
determining benchmark values of watermark parameters of a video according to a first size of at least one video frame in the video, wherein the watermark parameters include a second size of a watermark canvas, a third size of a watermark, and a position offset of the watermark in the watermark canvas;
for each of the at least one video frame, determining a first scaling ratio according to the first size of the video frame and the second size;
scaling the benchmark values of the watermark parameters according to the first scaling ratio; and generating a watermark for the video frame based on the scaled benchmark values.

According to one or more embodiments of the present disclosure, Example 2 provides the method of Example 1, wherein the determining benchmark values of watermark parameters of a video according to a first size of at least one video frame in the video includes:
determining a benchmark value of the second size according to the first size of the at least one video frame; and
determining a benchmark value of the third size and a benchmark value of the position offset according to the benchmark value of the second size.

According to one or more embodiments of the present disclosure, Example 3 provides the method of Example 2, wherein the first size includes a first width and a first height, and the second size includes a second width and a second height; and
the determining a benchmark value of the second size according to the first size of the at least one video frame includes:
determining a maximum value of the first width of the at least one video frame as a benchmark value of the second width, and
determining a maximum value of the first height of the at least one video frame as a benchmark value of the second height.

According to one or more embodiments of the present disclosure, Example 4 provides the method of Example 2, wherein the determining a benchmark value of the third size and a benchmark value of the position offset according to the benchmark value of the second size includes:
acquiring preset values of the watermark parameters;
determining a second scaling ratio according to the benchmark value of the second size and a preset value of the second size; and scaling a preset value of the third size with the second scaling ratio to obtain the benchmark value of the third size, and
scaling a preset value of the position offset with the second scaling ratio to obtain the benchmark value of the position offset.

According to one or more embodiments of the present disclosure, Example 5 provides the method of Example 4, wherein the second size includes a second width and a second height; and
the determining a second scaling ratio according to the benchmark value of the second size and a preset value of the second size includes:
calculating a first ratio of the benchmark value of the second width to a benchmark value of the second height, and a second ratio of a preset value of the second width to a preset value of the second height;
if the first ratio is greater than the second ratio, calculating a third ratio of the benchmark value of the second width to the preset value of the second width, and a fourth ratio of the preset value of the second height to the benchmark value of the second height; and
determining a product of the third ratio and the fourth ratio as the second scaling ratio.

According to one or more embodiments of the present disclosure, Example 6 provides the method of Example 5, wherein the determining a second scaling ratio according to the benchmark value of the second size and a preset value of the second size further includes:
if the first ratio is less than the second ratio, calculating a fifth ratio of the benchmark value of the second height to the preset value of the second height, and a sixth ratio of the preset value of the second width to the benchmark value of the second width; and
determining a product of the fifth ratio and the sixth ratio as the second scaling ratio.

According to one or more embodiments of the present disclosure, Example 7 provides the method of Example 5, wherein the determining a second scaling ratio according to the benchmark value of the second size and a preset value of the second size further includes:
if the first ratio is equal to the second ratio, determining the third ratio as the second scaling ratio.

According to one or more embodiments of the present disclosure, Example 8 provides the method of Example 1, wherein the first size includes a first width and a first height, and the second size includes a second width and a second height; and
the determining a first scaling ratio according to the first size of the video frame and the second size includes: calculating a seventh ratio of the first width of the video frame to a benchmark value of the second width, and an eighth ratio of the first height of the video frame to a benchmark value of the second height; and
determining a minimum value of the seventh ratio and the eighth ratio as the first scaling ratio.

According to one or more embodiments of the present disclosure, Example 9 provides a video watermark generation apparatus, including:
a benchmark value determination module, configured to determine benchmark values of watermark parameters of a video according to a first size of at least one video frame in the video, wherein the watermark parameters include a second size of a watermark canvas, a third size of a watermark, and a position offset of the watermark in the watermark canvas;
a scaling ratio determination module, configured to: for each of the at least one video frame, determine a first scaling ratio according to the first size of the video frame and the second size;
a parameter scaling module, configured to scale the benchmark values of the watermark parameters according to the first scaling ratio; and
a watermark generation module, configured to generate a watermark for the video frame based on the scaled benchmark values.

According to one or more embodiments of the present disclosure, Example 10 provides a computer-readable medium having a computer program stored thereon, wherein the computer program, when executed by a processing means, implements the steps of the method described in any one of Examples 1 to 8.

According to one or more embodiments of the present disclosure, Example 11 provides an electronic device, including: a storage means having a computer program stored thereon; and
a processing means, configured to execute the computer program in the storage means to implement the steps of the method described in any one of Examples 1 to 8.

According to one or more embodiments of the present disclosure, Example 12 provides a computer program product including a computer program, wherein when the computer program is executed by a processor, the steps of the method described in any one of Examples 1 to 8 are implemented.

The above description is merely illustration of preferred embodiments of the present disclosure and applied technical principles. Those skilled in the art should understand that the scope of disclosure involved in the present disclosure is not limited to the technical solutions formed by specific combinations of the above technical features, and shall also cover other technical solutions formed by any combination of the above technical features or equivalent features thereof without departing from the above disclosed concept, for example, the technical solution formed by replacing the above features with technical features having similar functions disclosed in the present disclosure (but not limited thereto).

In addition, although the various operations are depicted in a specific order, this should not be understood as requiring these operations to be performed in the specific order shown or in a sequential order. Under certain circumstances, multitasking and parallel processing may be advantageous. Similarly, although the above discussion contains a number of specific implementation details, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in terms specific to the structural features and/or method logic actions, it should be understood that the subject matter defined in the appended claims is not necessarily limited to the specific features or actions described above. Conversely, the specific features and actions described above are merely exemplary forms of implementing the claims. Regarding the apparatus in the above embodiments, the specific manner in which each module performs an operation has been described in detail in the embodiments relating to the method, and will not be detailed herein.

1. A video watermark generation method, comprising:
determining benchmark values of watermark parameters of a video based on a first size of at least one video frame in the video, wherein the watermark parameters comprise a second size of a watermark canvas, a third size of a watermark, and a position offset of the watermark in the watermark canvas;
determining, for each of the at least one video frame, a first scaling ratio based on the first size of the video frame and the second size;
scaling the benchmark values of the watermark parameters based on the first scaling ratio; and
generating a watermark for the video frame based on the scaled benchmark values.

2. The method of claim 1, wherein determining the benchmark values of the watermark parameters of the video based on the first size of the at least one video frame in the video comprises:
determining a benchmark value of the second size based on the first size of the at least one video frame; and
determining a benchmark value of the third size and a benchmark value of the position offset based on the benchmark value of the second size.

3. The method of claim 2, wherein the first size comprises a first width and a first height, and the second size comprises a second width and a second height; and
determining the benchmark value of the second size based on the first size of the at least one video frame comprises:
determining a maximum value of the first width of the at least one video frame as a benchmark value of the second width, and determining a maximum value of the first height of the at least one video frame as a benchmark value of the second height.

4. The method of claim 2, wherein determining the benchmark value of the third size and the benchmark value of the position offset based on the benchmark value of the second size comprises:
acquiring preset values of the watermark parameters;
determining a second scaling ratio based on the benchmark value of the second size and a preset value of the second size; and
scaling a preset value of the third size with the second scaling ratio to obtain the benchmark value of the third size, and scaling a preset value of the position offset with the second scaling ratio to obtain the benchmark value of the position offset.

5. The method of claim 4, wherein the second size comprises a second width and a second height; and
determining the second scaling ratio based on the benchmark value of the second size and the preset value of the second size comprises:
calculating a first ratio of the benchmark value of the second width to a benchmark value of the second height, and a second ratio of a preset value of the second width to a preset value of the second height;
in response to the first ratio being greater than the second ratio, calculating a third ratio of the benchmark value of the second width to the preset value of the second width, and calculating a fourth ratio of the preset value of the second height to the benchmark value of the second height; and
determining a product of the third ratio and the fourth ratio as the second scaling ratio.

6. The method of claim 5, wherein determining the second scaling ratio based on the benchmark value of the second size and the preset value of the second size further comprises:
in response to the first ratio being less than the second ratio, calculating a fifth ratio of the benchmark value of the second height to the preset value of the second height, and calculating a sixth ratio of the preset value of the second width to the benchmark value of the second width; and
determining a product of the fifth ratio and the sixth ratio as the second scaling ratio.

7. The method of claim 5, wherein determining the second scaling ratio based on the benchmark value of the second size and the preset value of the second size further comprises:
in response to the first ratio being equal to the second ratio, determining the third ratio as the second scaling ratio.

8. The method of claim 1, wherein the first size comprises a first width and a first height, and the second size comprises a second width and a second height; and
determining the first scaling ratio based on the first size of the video frame and the second size comprises:
calculating a seventh ratio of the first width of the video frame to a benchmark value of the second width, and an eighth ratio of the first height of the video frame to a benchmark value of the second height; and
determining a minimum value of the seventh ratio and the eighth ratio as the first scaling ratio.

9. A non-transitory computer-readable medium having a computer program stored thereon, wherein the computer program, when executed by a processor, causes the processor to:
determine benchmark values of watermark parameters of a video based on a first size of at least one video frame in the video, wherein the watermark parameters comprise a second size of a watermark canvas, a third size of a watermark, and a position offset of the watermark in the watermark canvas;
determine, for each of the at least one video frame, a first scaling ratio based on the first size of the video frame and the second size;
scale the benchmark values of the watermark parameters based on the first scaling ratio; and
generate a watermark for the video frame based on the scaled benchmark values.

10. The non-transitory computer-readable medium of claim 9, wherein the computer program that causes the processor to determine the benchmark values of the watermark parameters of the video based on the first size of the at least one video frame in the video comprises instructions to cause the processor to:
determine a benchmark value of the second size based on the first size of the at least one video frame; and
determine a benchmark value of the third size and a benchmark value of the position offset based on the benchmark value of the second size.

11. The non-transitory computer-readable medium of claim 10, wherein the first size comprises a first width and a first height, and the second size comprises a second width and a second height; and
the instructions that cause the processor to determine the benchmark value of the second size based on the first size of the at least one video frame comprise instructions to cause the processor to:
determine a maximum value of the first width of the at least one video frame as a benchmark value of the second width, and determine a maximum value of the first height of the at least one video frame as a benchmark value of the second height.

12. The non-transitory computer-readable medium of claim 11, wherein the instructions that cause the processor to determine the benchmark value of the third size and the benchmark value of the position offset based on the benchmark value of the second size comprise instructions to cause the processor to:
acquire preset values of the watermark parameters;
determine a second scaling ratio based on the benchmark value of the second size and a preset value of the second size; and
scale a preset value of the third size with the second scaling ratio to obtain the benchmark value of the third size, and scale a preset value of the position offset with the second scaling ratio to obtain the benchmark value of the position offset.

13. The non-transitory computer-readable medium of claim 12, wherein the second size comprises a second width and a second height; and
the instructions that cause the processor to determine the second scaling ratio based on the benchmark value of the second size and the preset value of the second size comprise instructions to cause the processor to:
calculate a first ratio of the benchmark value of the second width to a benchmark value of the second height, and a second ratio of a preset value of the second width to a preset value of the second height;
in response to the first ratio being greater than the second ratio, calculate a third ratio of the benchmark value of the second width to the preset value of the second width, and calculate a fourth ratio of the preset value of the second height to the benchmark value of the second height; and
determine a product of the third ratio and the fourth ratio as the second scaling ratio.

14. The non-transitory computer-readable medium of claim 13, wherein the instructions that cause the processor to determine the second scaling ratio based on the benchmark value of the second size and the preset value of the second size further comprise instructions to cause the processor to:
in response to the first ratio being less than the second ratio, calculate a fifth ratio of the benchmark value of the second height to the preset value of the second height, and calculate a sixth ratio of the preset value of the second width to the benchmark value of the second width; and
determine a product of the fifth ratio and the sixth ratio as the second scaling ratio.

15. The non-transitory computer-readable medium of claim 13, wherein the instructions that cause the processor to determine the second scaling ratio based on the benchmark value of the second size and the preset value of the second size further comprise instructions to cause the processor to:
in response to the first ratio being equal to the second ratio, determine the third ratio as the second scaling ratio.

16. The non-transitory computer-readable medium of claim 9, wherein the first size comprises a first width and a first height, and the second size comprises a second width and a second height; and
the computer program that causes the processor to determine the first scaling ratio based on the first size of the video frame and the second size comprises instructions to cause the processor to:
calculate a seventh ratio of the first width of the video frame to a benchmark value of the second width, and an eighth ratio of the first height of the video frame to a benchmark value of the second height; and
determine a minimum value of the seventh ratio and the eighth ratio as the first scaling ratio.

17. An electronic device, comprising:
a storage having a computer program stored thereon; and
a processor,
wherein the computer program in the storage, when executed by the processor, causes the processor to:
determine benchmark values of watermark parameters of a video based on a first size of at least one video frame in the video, wherein the watermark parameters comprise a second size of a watermark canvas, a third size of a watermark, and a position offset of the watermark in the watermark canvas;
determine, for each of the at least one video frame, a first scaling ratio based on the first size of the video frame and the second size;
scale the benchmark values of the watermark parameters based on the first scaling ratio; and
generate a watermark for the video frame based on the scaled benchmark values.

18. The electronic device of claim 17, wherein the computer program that causes the processor to determine the benchmark values of the watermark parameters of the video based on the first size of the at least one video frame in the video comprises instructions to cause the processor to:
determine a benchmark value of the second size based on the first size of the at least one video frame; and
determine a benchmark value of the third size and a benchmark value of the position offset based on the benchmark value of the second size.

19. The electronic device of claim 18, wherein the instructions that cause the processor to determine the benchmark value of the third size and the benchmark value of the position offset based on the benchmark value of the second size comprise instructions to cause the processor to:
acquire preset values of the watermark parameters;
determine a second scaling ratio based on the benchmark value of the second size and a preset value of the second size; and
scale a preset value of the third size with the second scaling ratio to obtain the benchmark value of the third size, and scale a preset value of the position offset with the second scaling ratio to obtain the benchmark value of the position offset.

20. The electronic device of claim 19, wherein the second size comprises a second width and a second height; and
the instructions that cause the processor to determine the second scaling ratio based on the benchmark value of the second size and the preset value of the second size comprise instructions to cause the processor to:
calculate a first ratio of the benchmark value of the second width to a benchmark value of the second height, and a second ratio of a preset value of the second width to a preset value of the second height;
in response to the first ratio being greater than the second ratio, calculate a third ratio of the benchmark value of the second width to the preset value of the second width, and a fourth ratio of the preset value of the second height to the benchmark value of the second height; and
determine a product of the third ratio and the fourth ratio as the second scaling ratio.
